(19) United States
(12) Patent Application Publication
(10) Pub. No.: US 2006/0091212 A1
(43) Pub. Date: May 4, 2006

(54) Chip card acceptor

(75) Inventors: Tien-Yuan Chien, Taipei (TW); Ting-Kuo Lin, Taipei (TW); Chia-Hung Hu, Taipei (TW)

Correspondence Address: INTERNATIONAL CURRENCY TECHNOLOGIES CORPORATION, 2F-4. NO. 148, SEC. 4, CHUNG HSIAN EAST ROAD, TAIPEI, TW

(73) Assignee: INTERNATIONAL CURRENCY TECHNOLOGIES CORPORATION, Taipei City. (TW)

(21) Appl. No.: 10/904,192

(22) Filed: Oct. 28, 2004

(51) Int. Cl. G06K 7/06

(52) U.S. Cl. 235/441

(57) ABSTRACT

A chip card acceptor is disclosed to include a housing having a front insertion hole for the insertion of a card or chip card, an electric connector mounted inside the housing for contacting the inserted card, a circuit board mounted inside the housing and electrically connected to the electric connector for reading storage data from the inserted card and transmitting fetched data to a main unit of an external system, and sensor means installed in the circuit board for verifying the authenticity of the inserted card for enabling the detection result and the storage data of the inserted card to be transmitted through the circuit board to the main unit of the external system for further processing.

### BACKGROUND OF THE INVENTION

1. Field of the Invention

The present invention relates to a chip card acceptor and more particularly, to such a chip card acceptor, which verifies the authenticity of the mark of the inserted card or chip card when reading storage data from the card.

2. Description of the Related Art

Following fast development of technology, our mode of living has been changed. Various vending machines are used everywhere to sell any of a variety of products without the service of any serviceman. These vending machines include beverage vending machines, cigarette vending machines, ticket vending machines, ice-cream vending machines, memorial coins and keyring vending machines. It is incredibly that hamburger and noodle vending machines are available nowadays on the market. These automatic vending machines bring convenience to our life. However, some vending machines sell products (for example, tobaccos and wines) that are limited to persons over 18 years old. These vending machines use a card acceptor to check the qualification of the user. When using a vending machine of this kind, the user must insert one's motorcycle driving license or automobile driving license into the card acceptor of the vending machine. The card acceptor uses a sensor to detect the mark of the inserted card so as to verify the authenticity of the inserted card. Following the step of time, plastic money has been intensively used for transaction instead of coins and banknotes. The currently used credit cards adopt magnetic strip technology. These credit cards are called “magnetic strip cards”. The history of the use of credit cards in the market has over 30 years. However, current magnetic strip security system cannot eliminate criminals from using stolen credit cards or counterfeiting credit cards. In order to eliminate this problem, chip cards are developed to substitute for magnetic strip cards. However, a vending machine that accept chip cards and sell special products limited to persons over 18 years old must provide a chip card reader to read storage data from the chip of the inserted chip card and a card acceptor to check the qualification of inserted identification card. It is not economic to have a vending machine equipped with a chip card reader and a card acceptor.

Therefore, it is desirable to provide a chip card acceptor that can read storage data from the chip of the inserted chip card and verify the authenticity of the mark at the inserted chip card.

### SUMMARY OF THE INVENTION

The present invention has been accomplished under the circumstances in view. It is therefore the main object of the present invention to provide a chip card acceptor, which verifies the authenticity of the mark of the inserted card or chip card when reading storage data from the card. To achieve this and other objects of the present invention, the chip card acceptor comprises a housing having a front insertion hole for the insertion of a card or chip card, an electric connector mounted inside the housing for contacting a chip of the inserted card, a circuit board mounted inside the housing and electrically connected to the electric connector for reading storage data from the inserted card and transmitting fetched data to a main unit of an external system, and sensor means installed in the circuit board for verifying the authenticity of the mark of the inserted card for enabling the detection result and the storage data of the inserted card to be transmitted through the circuit board to the main unit of the external system for further processing.

### BRIEF DESCRIPTION OF THE DRAWING

FIG. 1 is an exploded view of a chip card acceptor according to the present invention.

FIG. 2 is an assembly view in an enlarged scale of the chip card acceptor shown in FIG. 1.

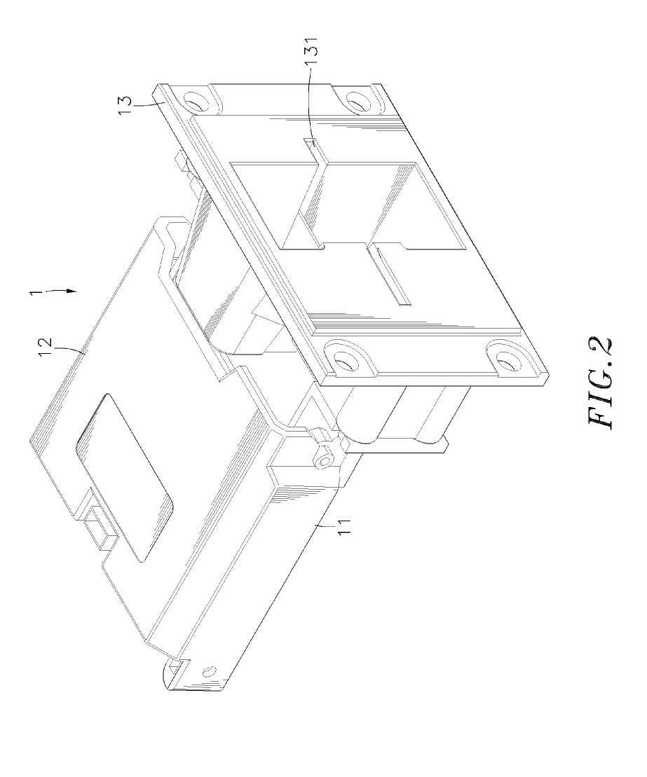

FIG. 3 is a sectional view of the present invention, showing a card or chip card inserted into the insertion hole of the chip card acceptor.

FIG. 4 is similar to FIG. 3 but showing the inserted card pushed to the inside of the housing;

FIG. 5 is similar to FIG. 4 but showing the inserted card kept in contact with the contact terminals of the electric connector in the recessed hole of the bottom cover shell.

FIG. 6 is an elevational view of an alternate form of the chip card acceptor according to the present invention.

FIG. 7 is a side view in section of the chip card acceptor shown in FIG. 6.

### DETAILED DESCRIPTION OF THE EMBODIMENT

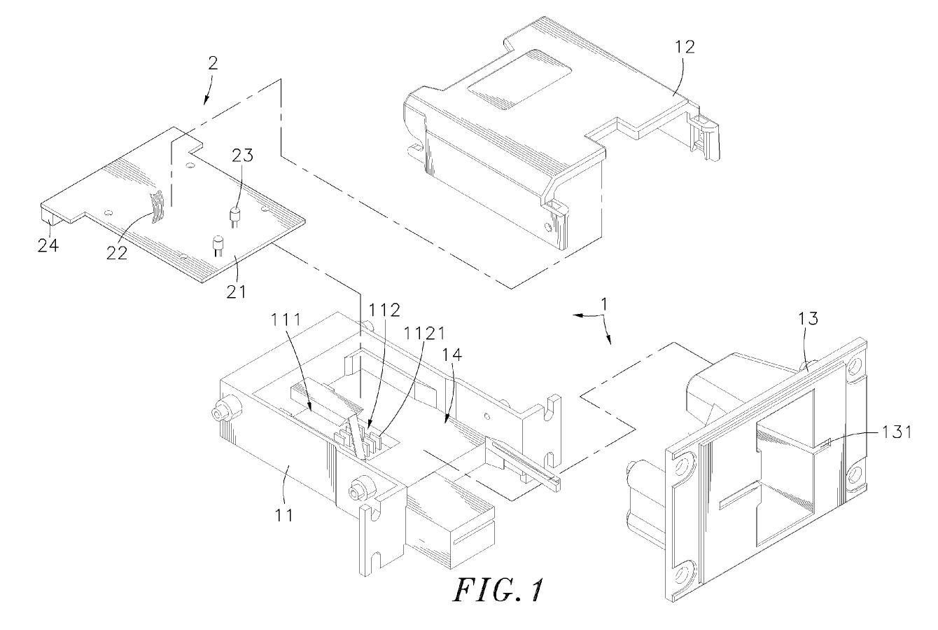

Referring to FIGS. 1˜3, a chip card acceptor in accordance with the present invention is shown comprised of a housing 1 and a controller 2.

The housing 1 is comprised of a bottom cover shell 11, a top cover shell 12, and a front cover shell 13. The top cover shell 12 and the front cover shell 13 are respectively fastened to the top and front sides of the bottom cover shell 11 and define with the bottom cover shell 11 a receiving chamber 14. The front cover shell 13 has an insertion hole 131 in communication with the receiving chamber 14. The bottom cover shell 111 has a recessed hole 111 on the inside, a plurality of sliding tracks 1111 symmetrically disposed at two sides inside the recessed hole 111, and an electric connector 112 mounted in the recessed hole 111. The electric connector 112 comprises a plurality of contact terminals 1121, a plurality of rails 1122 symmetrically disposed at the two opposite lateral sides thereof and respectively coupled to the sliding tracks 1111 in the recessed hole 111, and a handle 1123 suspending in the receiving chamber 14.

The controller 2 comprises a circuit board 21 mounted in the receiving chamber 14 inside the bottom cover shell 11, a bus line 22 extended from the circuit board 21 and electrically connected to the contact terminals 1121 of the electric connector 112 in the recessed hole 111, sensor means 23 disposed at the top side, and an electric connection port 24 disposed at the bottom side for connection to the main unit of a vending machine or the like.

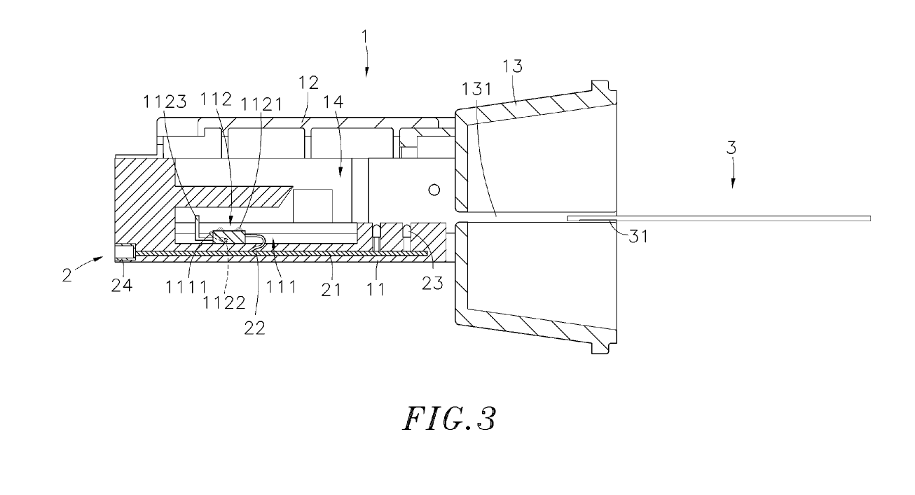

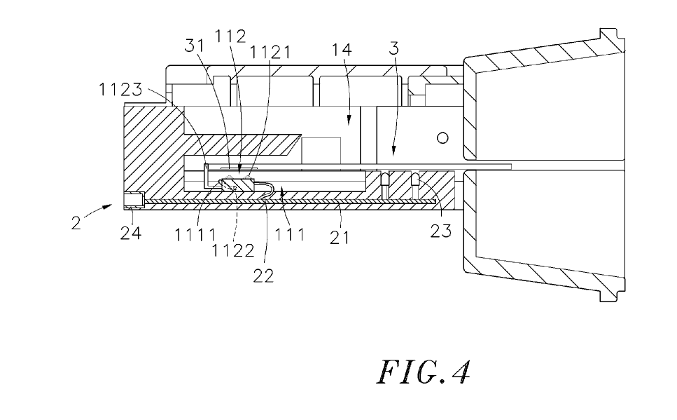

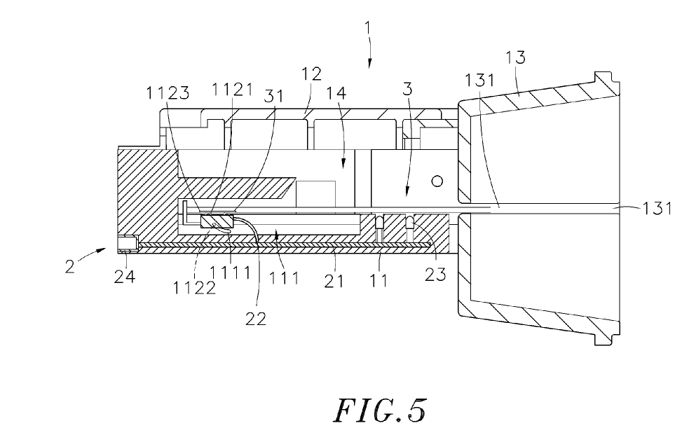

Referring to FIGS. 4 and 5 and FIG. 3 again, when the user inserting a card or chip card 3 into the insertion hole 131 of the housing 1, the card or chip card 33 will touch the handle 1123 of the electric connector 112. When the user pushes the card or chip card 3 forwards, the rails 1122 will be moved with the electric connector 112 inwards along the sliding tracks 1111 in the recessed hole 111, thereby causing the contact terminals 1121 to contact the chip 31 of the card or chip card 3. At this time, the main unit of the vending machine can fetch data from a chip 31 of the card or chip card 3 through the electric connector 112. The sensor means 23 can be an optical transmitter receiver circuit that emits light onto the mark at the card or chip card 3 and receives reflected light from the mark at the card or chip card 3 for judging the authenticity of the card or chip card 3 and the identification of the holder of the card or chip card 3. According to the present invention, the card or chip card 3 can be a driver's motorcycle or automobile license, or an identification card. The detection result is sent from the sensor means 23 through the electric connection port 24 to the main unit of the vending machine so that the main unit of the vending machine can determine the operation subject to the data determined by the chip card acceptor. After end of use, the card or chip card 3 is ejected out of the insertion hole 131.

Further, the chip card acceptor can be designed to read data from the chip 31 of the card or chip card 3 or judge the authenticity and position of the mark of the card or chip card 3, or to simultaneously read data from the chip 31 of the card or chip card 3 and judge the authenticity and position of the mark of the card or chip card 3. The mark of the card or chip card 3 can be a watermarking or laser-tag.

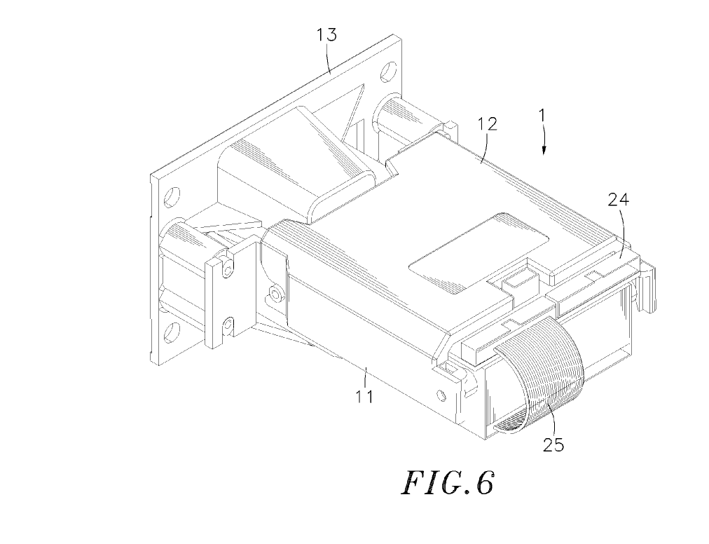

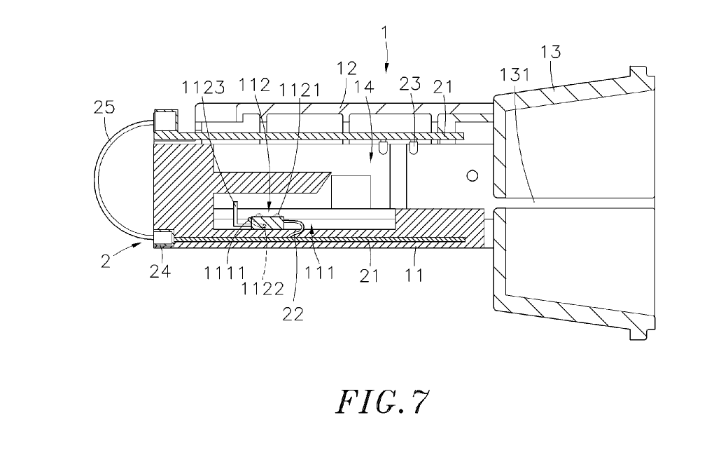

FIGS. 6 and 7 show an alternate form of the chip card acceptor according to the present invention. According to this design, the controller 2 comprises two circuit boards 21 respectively horizontally mounted in the bottom cover shell 111 and the top cover shell 12 of the housing 1 to hold the sensor means 23 in the top side of the receiving chamber 14 and the electric connector 112 in the recessed hole 111 in the bottom side of the receiving chamber 14 respectively, and an electric connection line 25 is installed to electrically connect the two circuit boards 21. According to this embodiment, the chip card acceptor can be applicable to different type of the card or chip card 3. Further, the sensor means 23 is comprised of a light emitting diode.

As indicated above, the technical key points of the chip card acceptor that eliminates the drawbacks of the prior art designs are that the housing houses a circuit board electrically connectable to the main unit of an external system, an electric connector electrically connected to the circuit board for electric connection to the inserted card to fetch storage data from the inserted card, and a sensor electrically connected to the circuit board for verifying the authenticity of the ID mark at the inserted card. Therefore, the chip card acceptor can verify the authenticity of the ID mark of the inserted card to check the identification of the holder of the inserted card while reading storage data from the inserted card.

A prototype of chip card acceptor has been constructed with the features of FIGS. 1˜7. The chip card acceptor functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A chip card acceptor adapted to verify the authenticity of the mark of a card or chip card and to read storage data from the card, comprising a housing, said housing comprising an inside receiving chamber and a front insertion hole in communication with said inside receiving chamber for the insertion of a card or chip card, an electric connector mounted inside said inside receiving chamber for contacting the card or chip card inserted into said front insertion hole electrically, and detection circuit means mounted inside said inside receiving chamber and electrically connected to said electric connector and adapted to verify the authenticity of the mark of the card or chip card inserted into said front insertion hole, wherein said detection circuit means comprises a circuit board electrically connected to said electric connector for reading storage data from the inserted card through said electric connector, said circuit board having an electric connection port electrically connectable to a main unit of an external system, sensor means installed in said circuit board and suspending in said inside receiving chamber and adapted to verify the authenticity of the mark of the card or chip card inserted into said front insertion hole for enabling the detection result and the storage data of the inserted card to be transmitted through said electric connection port to the main unit of the external system for further processing.

2. The chip card acceptor as claimed in claim 1, wherein said circuit board is comprised of two parts respectively mounted in top and bottom sides inside said inside receiving chamber; said electric connector and said sensor means are respectively installed in the two parts of said circuit board in bottom and top sides inside said inside receiving chamber.

3. The chip card acceptor as claimed in claim 2, further comprising an electric connection line electrically connected between the two parts of said circuit board.

4. The chip card acceptor as claimed in claim 1, wherein said electric connector is electrically connected to said circuit board through a bus line.

5. The chip card acceptor as claimed in claim 1, wherein said housing comprises a recessed hole disposed inside said inside receiving chamber and adapted to accommodate said electric connector; said electric connector is mounted in the recessed hole inside said receiving chamber, comprising a plurality of contact terminals adapted to contact the inserted card.

6. The chip card acceptor as claimed in claim 5, wherein said housing comprises a plurality of sliding tracks symmetrically disposed at two opposite lateral sides inside said recessed hole; said electric connector comprises a plurality of rails respectively coupled to said sliding tracks for guiding horizontal movement of said electric connector in said recessed hole along said sliding tracks, and a handle protruding over said recessed hole for pushing by the card or chip card inserted into said front insertion hole.

7. The chip card acceptor as claimed in claim 1, wherein said housing comprises a bottom cover shell, a top cover shell covered on a top side of said bottom cover shell, and a front cover shell covered on said bottom cover shell and said top cover shell at a front side.

8. The chip card acceptor as claimed in claim 1, wherein the mark of the card or chip card readable to said sensor means is a watermarking.

9. The chip card acceptor as claimed in claim 1, wherein the mark of the card or chip card readable to said sensor means is a laser-tag.

10. The chip card acceptor as claimed in claim 1, wherein said sensor means is comprised of a light emitting diode.
